(19) United States
(12) Patent Application Publication
(10) Pub. No.: US 2022/0126367 A1
(43) Pub. Date: Apr. 28, 2022

(54) PROCESS FOR MANUFACTURING AN ALUMINUM ALLOY PART

(71) Applicant: C-TEC Constellium Technology Center, Voreppe (FR)

(72) Inventors: Bechir CHEHAB, Voiron (FR); Ravi SHAHANI, Voreppe (FR)

(21) Appl. No.: 17/430,589

(22) PCT Filed: Feb. 13, 2020
(86) PCT No.: PCT/FR2020/050266

§ 371 Date: Aug. 12, 2021

(30) Foreign Application Priority Data
Feb. 15, 2019 (FR) 1901575
Oct. 11, 2019 (FR) 1911356

(51) Int. Cl. B22F 10/20; C22F 1/04; B33Y 40/20; C22C 21/00; B22F 7/00; B33Y 10/00; B33Y 70/00; B33Y 80/00

(52) U.S. Cl. CPC B22F 10/20; C22F 1/04; B33Y 40/20; C22C 21/00; B22F 2301/052; B33Y 10/00; B33Y 70/00; B33Y 80/00; B22F 7/008

(57) ABSTRACT

A method for manufacturing a part (20) including a formation of successive metallic layers (20₁ . . . 20ₙ), superimposed on one another, each layer being formed by the deposition of a filler metal (15, 25), the filler metal being subjected to an energy input so as to melt and constitute, when solidifying, said layer, the method being characterized in that the filler metal (15, 25) is an aluminum alloy including the following alloy elements (weight %):
Ni: >3% and ≤7%;
Fe: 0%-4%;
optionally Zr: ≤0.5%;
optionally Si: ≤0.5%;
optionally Cu: ≤1%;
optionally Mg: ≤0.5%;
other alloy elements: <0.1% individually, and <0.5% all in all;
impurities: <0.05% individually, and <0.15% all in all;
   the remainder consisting of aluminum.

### TECHNICAL FIELD

The technical field of the invention is a method for manufacturing a part made of an aluminum alloy, implementing an additive manufacturing technique.

### PRIOR ART

Since the 80s, additive manufacturing techniques have been developed, which consist in shaping a part by addition of matter, in contrast with machining techniques, aiming to remove the matter. Formerly restricted to prototyping, additive manufacturing is now operational for manufacturing industrial products in mass production, including metallic parts.

The term “additive manufacturing” is defined according to the French standard XP E67-001: “a set of processes allowing manufacturing, layer after layer, by addition of matter, a physical object based on a digital object”. The standard ASTM F2792-10 defines additive manufacturing too. Different additive manufacturing approaches are also defined and described in the standard ISO/ASTM 17296-1. Resort to an additive manufacture to make an aluminum part, with low porosity, has been described in the document WO2015006447. In general, the application of successive layers is carried out by application of a so-called filler material, and then melting or sintering of the filler material using an energy source such as a laser beam, an electron beam, a plasma torch or an electric arc. Regardless of the additive manufacturing approach that is applied, the thickness of each added layer is in the range of a few tens or hundreds of microns.

Other publications describe the use of aluminum alloys as a filler material, in the form of a powder or a wire. The publication Gu J. “Wire-Arc Additive Manufacturing of Aluminium” Proc. 25th Int. Solid Freeform Fabrication Symp., August 2014, University of Texas, 451-458, describes an example of application of an additive manufacturing approach referred to by the term WAAM, acronym of “Wire+Arc Additive Manufacturing” on aluminum alloys to make parts with a low porosity intended for the aeronautical industry. The WAAM process is based on arc welding. It consists in stacking different layers successively one on top of another, each layer corresponding to a weld bead formed from a wire. This allows obtaining a relatively large cumulated mass of deposited material, which may reach 3 kg/h. When this method is implemented using an aluminum alloy, the latter is generally a 2319-type alloy. The publication Fixter “Preliminary Investigation into the Suitability of 2xxx Alloys for Wire-Arc Additive Manufacturing” studies the mechanical properties of parts manufactured using the WAAM method, using several aluminum alloys. More particularly, with the copper content being kept between 4 and 6 weight %, the authors have varied the magnesium content and determined he hot cracking susceptibility of 2xxx alloys during the implementation of a WAAM-type process. The authors have concluded that an optimum magnesium content is 1.5%, and that the 2024 aluminum alloy is particularly suitable.

Other additive manufacturing methods may be used. Mention may be made for example, and without limitation, of melting or sintering of a filler material in the form of a powder. This may consist of laser melting or sintering. The patent application US20170016096 describes a method for manufacturing a part by local melting obtained by exposure of a powder to an energy beam such as an electron beam or a laser beam, the method being also referred to by the acronyms SLM, standing for “Selective Laser Melting” or “EBM”, standing for “Electron Beam Melting”. The mechanical properties of the aluminum parts obtained by additive manufacturing depend on the alloy forming the filler metal, and more specifically on its composition as well as on the heat treatments applied following the implementation of the additive manufacture.

The 4XXX-type aluminum-silicon alloys, optionally including Mg, are currently considered to be the most mature alloys for the application of the SLM process. However, this type of alloys may have some difficulties during anodization. In addition, their thermal and electrical conductivities are limited.

The inventors have determined an alloy composition which, when used in an additive manufacturing method, allows obtaining parts combining good mechanical properties together with a good electrical conductivity.

### DISCLOSURE OF THE INVENTION

A first object of the invention is a method for manufacturing a part including a formation of successive metallic layers, superimposed on one another, each layer being formed by the deposition of a filler metal, the filler metal being subjected to an energy input so as to melt and constitute, when solidifying, said layer, the method being characterized in that the filler metal is an aluminum alloy including the following alloy elements (weight %):
Ni: >3% et ≤7%;
Fe: 0%-4%;
optionally Zr: ≤0.5%;
optionally Si: ≤0.5% and preferably ≤0.2% or ≤0.1%;
optionally Cu: ≤1% and preferably ≤0.5%, more preferably ≤0.2%, or ≤0.1%;
optionally Mg: ≤0.5% and preferably ≤0.2% or ≤0.1%;
other alloy elements: <0.1% individually, and <0.5% all in all;
impurities: <0.05% individually, and <0.15% all in all;
   the remainder consisting of aluminum.

Among the other alloy elements, mention may be made for example of Cr, V, Ti, Mn, Mo, W, Nb, Ta, Sc, Zn, Hf, Nd, Ce, Co, La, Ag, Li, Y, Yb, Er, Sn, In, Sb, Sr, Ba, Bi, Ca, P, B and/or a mischmetal. In a manner known to those skilled in the art, the composition of the mischmetal generally consists of about 45 to 50% of cerium, 25% of lanthanum, 15 to 20% of neodymium and 5% of praseodymium. The weight fraction of each other alloy element may be lower than 500 ppm, or than 300 pm, or than 200 ppm, or than 100 ppm.

The method may include the following features, considered separately or according to technically feasible combinations:
Ni: 3.5%-6% or Ni: 3.5%-5%;
Fe: 0.5%-3% or Fe: <1%;

In particular, each layer may feature a pattern defined from a digital model.

The method may include, following the formation of the layers, an application of at least one heat treatment. The heat treatment may consist of or include a stress relief, a tempering or an annealing, which may be performed for example at a temperature preferably comprised from 200° C. to 500° C. It may also include a solution heat treatment and a quenching. It may also include hot isostatic pressing.

According to an advantageous embodiment, the method includes no quenching-type heat treatment following the formation of the layers. Thus, preferably, the method does not include any steps of solution heat treatment followed by quenching.

According to one embodiment, the filler metal is in the form of a powder, whose exposure to a beam of light or of charged particles, results in a local melting followed by a solidification, so as to form a solid layer. According to another embodiment, the filler metal is derived from a filler wire, whose exposure to a heat source, for example an electric arc, results in a local melting followed by a solidification, so as to form a solid layer.

A second object of the invention is a metallic part, obtained after application of a method according to the first object of the invention.

A third object of the invention is a material, in particular in the form of powder or a wire, intended to be used as a filler material of an additive manufacturing method, characterized in that it is constituted by an aluminum alloy, including the following alloy elements (weight %):
Ni: >3% et ≤7%;
Fe: 0%-4%;
optionally Zr: ≤0.5%;
optionally Si: ≤0.5% and preferably ≤0.2% or ≤0.1%;
optionally Cu: ≤1% and preferably ≤0.5%, more preferably ≤0.2% or ≤0.1%;
optionally Mg: ≤0.5% and preferably ≤0.2% or ≤0.1%;
other alloy elements: <0.1% individually, and <0.5% all in all;
impurities: <0.05% individually, and <0.15% all in all;
   the remainder consisting of aluminum.

The aluminum alloy forming the filler material may feature any one of the characteristics described in connection with the first object of the invention.

The filler material may be in the form of a powder. The powder may be such that at least 80% of the particles composing the powder have an average size within the following range: 5 μm to 100 μm, preferably from 5 to 25 μm, or from 20 to 60 μm.

When the filler material is in the form of a wire, the diameter of the wire may in particular be from 0.5 mm to 3 mm, and preferably from 0.5 mm to 2 mm, and still preferably from 1 mm to 2 mm.

Other advantages and features will appear more clearly from the following description of particular embodiments of the invention, provided as non-limiting examples, and represented in the figures listed hereinbelow.

### FIGURES

FIG. 1 is a diagram illustrating a SLM-type additive manufacturing method.

FIG. 2 illustrates tensile and electrical conduction properties determined throughout experimental tests, from samples manufactured by implementing an additive manufacturing method according to the invention.

FIG. 3 is a diagram illustrating a WAAM-type additive manufacturing method.

FIG. 4 is a geometry of a specimen used to perform tensile tests.

### DISCLOSURE OF PARTICULAR EMBODIMENTS

Unless stated otherwise, in the description:
the designation of the aluminum alloys is compliant with the nomenclature of The Aluminum Association;
the contents of the chemical elements are reported in % and represent weight fractions. The x %-y % notation means higher than or equal to x % and lower than or equal to y %.

By impurities, it should be understood chemical elements that are unintentionally present in the alloy.

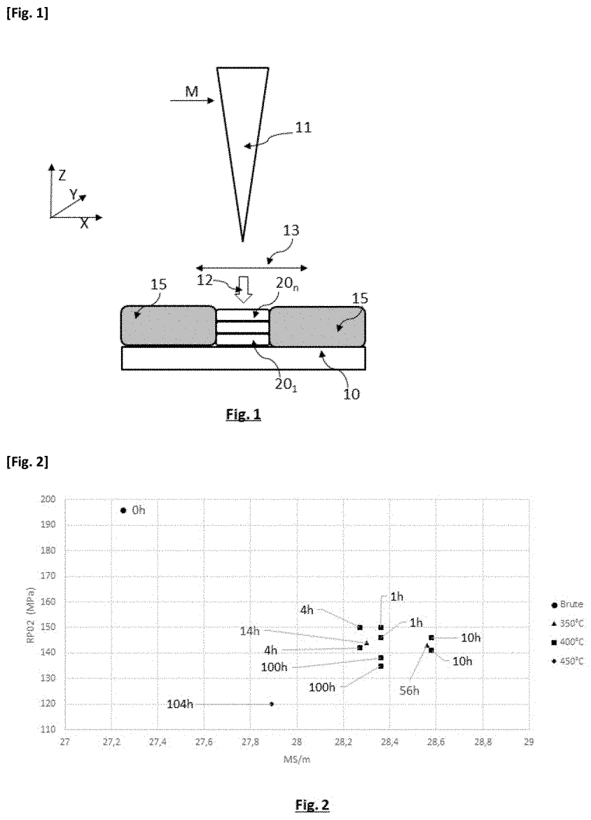

FIG. 1 schematizes the operation of a Selective Laser Melting (SLM) type additive manufacturing method. The filler metal 15 is in the form of a powder disposed on a support 10.

An energy source, in this instance a laser source 11, emits a laser beam 12. The laser source is coupled to the filler material by an optical system 13, whose movement is determined according to a digital model M. The laser beam 12 propagates according to an axis of propagation Z, and follows a movement according to a plane XY, describing a pattern depending on the digital model. For example, the plane is perpendicular to the axis of propagation Z. The interaction of the laser beam 12 with the powder 15 causes a selective melting of the latter, followed by a solidification, resulting in the formation of a layer 20₁ . . . 20ₙ. Once a layer has been formed, it is covered with powder 15 of the filler metal and another layer is formed, superimposed on the layer made before. For example, the thickness of the powder forming a layer may be from 10 to 200 μm.

The powder may have at least one of the following characteristics:
Average particle size from 5 to 100 μm, preferably from 5 to 25 μm, or from 20 to 60 μm. The given values mean that at least 80% of the particles have an average size within the specified range.
Spherical shape. For example, the sphericity of a powder may be determined using a morphogranulometer.
Good castability. For example, the castability of a powder may be determined according to the standard ASTM B213 or the standard ISO 4490: 2018. According to the standard ISO 4490: 2018, the flow time is preferably shorter than 50 s;
Low porosity, preferably from 0 to 5%, more preferably from 0 to 2%, still more preferably from 0 to 1% by volume. In particular, the porosity may be determined by analysis of images from optical micrographs or by helium pycnometry (cf. the standard ASTM B923);
Absence or small amount (less than 10%, preferably less than 5% by volume) of small particles (1 to 20% of the average size of the powder), called satellites, which stick to the larger particles.

Such a powder is particularly suited to the implementation of a SLM-type method. Such a method allows carrying out a parallel manufacture of several monolithic parts, and that being so at a reasonable cost.

The inventors have implemented a SLM-type additive manufacturing method to make parts intended for aircrafts, for example structural elements. However, the inventors have observed that the application of quenching-type heat treatments could induce a distortion of the part, because of the abrupt variation of temperature. In general, the distortion of the part is even more significant as its dimensions are large. Yet, the advantage of an additive manufacturing method is precisely to obtain a part whose shape, after manufacture, is permanent, or almost-permanent. Hence, the occurrence of a significant deformation resulting from a heat treatment shall be avoided. By almost-permanent, it should be understood that a finish machining might be performed on the part after manufacture thereof: the part manufactured by additive manufacturing extends according to its permanent shape, prior to finish machining.

After having noticed the foregoing, the inventors have looked for an alloy composition, forming the filler material, allowing obtaining acceptable mechanical properties, without requiring the application of heat treatments, subsequent to the formation of the layers, which might induce a distortion. In particular, the aim is to avoid heat treatments involving an abrupt variation of the temperature. Thus, the invention allows obtaining, by additive manufacturing, a part whose mechanical properties, as well as thermal or electrical conduction properties, are satisfactory. Depending on the selected additive manufacturing method type, the filler material may be in the form of a wire or a powder.

The inventors have noticed that by limiting the number of elements present in the alloy, beyond a content of 1% or 0.5%, a good trade-off between the mechanical and thermal or electrical conduction properties is obtained. It is commonly recognized that the addition of elements in the alloy allows improving some mechanical properties of the part made by additive manufacturing. By mechanical properties, it should be understood for example the yield strength and the elongation at break. However, the addition of a too large amount, or of a too wide variety, of alloy chemical elements could alter the thermal or electrical conduction properties of the part resulting from the additive manufacture.

The inventors have considered it useful to reach a compromise between the number and the amount of elements added in the alloy, so as to obtain acceptable mechanical and thermal (or electrical) conduction properties.

The inventors consider that such a compromise is obtained by limiting to only 1 or two the number of chemical elements forming the aluminum alloy having a weight fraction higher than or equal to 1% or 0.5%.

The Ni content of an aluminum alloy implemented in the invention is strictly higher than 3%, and preferably higher than or equal to 3.5%. Preferably, it is lower than or equal to 7% or to 6% or to 5%. Thus:
3%<Ni≤7% or 3%<Ni≤6% or 3%<Ni≤5%;
and, preferably, 3.5%<Ni≤7% or 3.5%<Ni≤6% or 3.5%<Ni≤5%;

It is considered that the electrical (or thermal) conductivity decreases when the Ni concentration increases. Conversely, when the Ni concentration increases, the mechanical properties of the manufactured part improve. It is estimated that a best trade-off between conductivity and mechanical properties is obtained when the weight fraction of Ni is from 3.5% to 6% or from 3.5% to 5%.

Such a Nickel content allows maintaining a relatively low liquidus temperature, in the range of 650° C., when the alloy is binary, or may be considered to be binary because of the low weight fraction of other elements in the alloy. This makes the alloy particularly suited to an implementation by an additive manufacturing type process.

Besides Ni, the aluminum alloy may include Fe. In this case, the weight fraction of Fe is preferably lower than or equal to 4%. Thus, 0%≤Fe≤4%. Preferably, 0.5%≤Fe≤3%. According to one embodiment, Fe<1%. The presence of Fe in the alloy allows improving the mechanical properties, whether these consist of tensile mechanical properties or hardness. This is attributed to a formation of hardening fine dispersoids during the implementation of the additive manufacturing method.

Besides Ni and optionally Fe, the aluminum alloy implemented in the invention may include Zr, according to a weight fraction lower than or equal to 1%, or lower than or equal to 0.5%. Thus, 0%≤Zr≤0.5% or 0%≤Zr≤1%. When the alloy includes Zr, the method preferably includes a post-manufacture heat treatment of the part resulting from the implementation of the additive manufacturing method. The presence of Zr then contributes to improving the mechanical properties, in particular the hardness, by the formation of Al₃Zr precipitates at a temperature close to 400° C. The heat treatment may be a stress relief, a tempering or an annealing, performed at a temperature preferably from 200° C. to 500° C., and preferably from 300° C. to 450° C.

The addition of Fe or Zr is considered as having no significant impact on the thermal conductivity, because of their low solubility at a temperature close to 400° C.

According to one embodiment, the aluminum alloy may include Si, with Si≤0.5%, or Si≤0.2%, or Si≤0.1%. The aluminum alloy may also include other alloy elements, such as Cr, V, Ti, Mn, Mo, W, Nb, Ta, Sc, Zn, Hf, Nd, Ce, Co, La, Ag, Li, Y, Yb, Er, Sn, In, Sb, Sr, Ba, Bi, Ca, P, B and/or a mischmetal, according to a weight fraction individually strictly lower than 0.1% preferably lower than 500 ppm, and preferably lower than 300 ppm, or 200 ppm, or 100 ppm. However, some of these alloy elements, in particular Cr, V, Ti and Mo degrade conductivity. It is preferable that the alloy contains as less as possible of them. Thus, the weight fraction of Cr, V, Ti and Mo is preferably strictly lower than 500 ppm, 200 ppm or 100 ppm.

According to one embodiment, the aluminum alloy may include Cu, with Cu≤1%, or Cu≤0.5%, or ≤0.2%, or ≤0.1%. The presence of Cu slightly lowers the thermal or electrical conductivity.

In addition to good mechanical and electrical or thermal conductivity properties, the alloy as previously described includes the following advantages:
a composition may be devoid of rare materials, for example Sc or rare earths;
a good corrosion resistance: indeed, it is considered that rapidly solidified microstructures formed from alloys based on transition metals have a good corrosion resistance. A possible cause is the absence of large particles, usually referred to as “coarse particles” by those skilled in the art;
a good compatibility with surface treatment electrochemical processes, in particular anodization, by the absence, or the small amount, of Si and the fineness of the microstructure formed following the rapid solidification of the alloy.

Moreover, the alloy as previously described features good mechanical properties and a good electrical conductivity yet without it being necessary to apply a post-manufacture heat treatment. As described later on, in the experimental examples, the application of a tempering- or annealing-type heat treatment allows improving the electrical conductivity (or the thermal conductivity). However, it is also accompanied with a decrease in the mechanical properties. In particular, the temperature of the possible heat treatment may be from 300° C. to 500° C. The duration of the possible heat treatment may be from 1 h to 100 h.

A linear dependency relationship of thermal conductivity and of electrical conductivity, according to Wiedemann Franz law, has been validated in the publication Hatch “Aluminum properties and physical metallurgy” ASM Metals Park, OH, 1988. Thus, the alloy as previously described allows obtaining parts having a high thermal conductivity.

In general, the method according to the present invention is carried out on a construction tray. Without being bound by theory, it seems that heating the construction tray up to a temperature from 50 to 300° C. could be advantageous to reduce the residual stresses that might induce a distortion of the part and optionally thermally-induced cracks.

According to one embodiment, the method may include a hot isostatic pressing (HIP) step. In particular, the HIP treatment may allow improving the elongation properties and the fatigue properties. The hot isostatic pressing may be carried out before, after or instead of the heat treatment. Advantageously, the hot isostatic pressing is carried out at a temperature from 250° C. to 500° C. and preferably from 300° C. to 450° C., at a pressure from 500 to 3000 bars and over a duration from 0.5 to 100 hours.

In particular, the possible heat treatment and/or the hot isostatic pressing allows increasing the electrical or thermal conductivity of the obtained product.

According to another embodiment, suited to alloys with structural hardening, it is possible to carry out a solution heat treatment followed by quenching and tempering of the formed part and/or a hot isostatic pressing. In this case, the hot isostatic pressing may advantageously replace the solution heat treatment.

However, the method according to the invention is advantageous, because it preferably does not require any solution heat treatment followed by quenching. The solution heat treatment may have a detrimental effect on the mechanical strength in some cases by participating in an enlargement of dispersoids or fine intermetallic phases.

According to one embodiment, the method according to the present invention further includes, optionally, a machining treatment, and/or a chemical, electrochemical or mechanical surface treatment, and/or a vibratory finishing. In particular, these treatments may be carried out to reduce the roughness and/or improve the corrosion resistance and/or improve the resistance to fatigue cracking.

Optionally, it is possible to carry out a mechanical deformation of the part, for example after the additive manufacture and/or before the heat treatment.

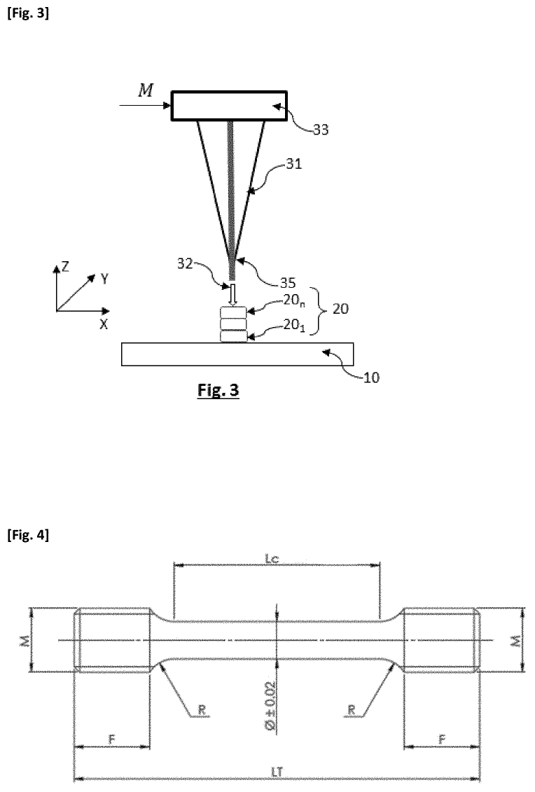

Although described in connection with a SLM-type additive manufacturing method, the method may be applied to other WAAM-type additive manufacturing methods, mentioned in connection with the prior art. FIG. 3 represents such an alternative. An energy source 31, in this instance a torch, forms an electric arc 32. In this device, the torch 31 is held by a welding robot 33. The part 20 to be manufactured is disposed on a support 10. In this example, the manufactured part is a wall extending according to a transverse axis Z perpendicular to a plane XY defined by the support 10. Under the effect of the electric arc 12, the filler wire 35 melts so as to form a welding bead. The welding robot is controlled by a digital model M. It is moved so as to form different layers 20₁ . . . 20ₙ, stacked on one another, forming the wall 20, each layer corresponding to a welding bead. Each layer 20₁ . . . 20ₙ extends in the plane XY, according to a pattern defined by the digital model M.

Preferably, the diameter of the filler wire is smaller than 3 mm. It may be from 0.5 mm to 3 mm and is preferably from 0.5 mm to 2 mm, or from 1 mm to 2 mm. For example, it is 1.2 mm.

Moreover, other methods may be considered, for example, and without limitation:
Selective Laser Sintering (or SLS);
Direct Metal Laser Sintering (or DMLS);
Selective Heat Sintering (or SHS);
Electron Beam Melting (or EBM);
Laser Melting Deposition;
Direct Energy Deposition (or DED);
Direct Metal Deposition (or DMD);
Direct Laser Deposition (or DLD);
Laser Deposition Technology;
Laser Engineering Net Shaping;
Laser Cladding Technology;
Laser Freeform Manufacturing Technology (or LFMT);
Laser Metal Deposition (or LMD);
Cold Spray Consolidation (or CSC);
Additive Friction Stir (or AFS);
Field Assisted Sintering Technology, FAST or spark plasma sintering; or
Inertia Rotary Friction Welding (or IRFW).

### Experimental Examples

First tests have been carried out using an alloy, whose weight composition included, besides Al, Ni: 4%, Fe: 1%, impurities: <0.05% with cumulated impurities <0.15%.

Test parts have been made by SLM, using a EOS M290 SLM (supplier EOS) type machine. The power of the laser was 290 W. The scan speed was equal to 1275 mm/s. The deviation between two adjacent scan lines, usually referred to by the term “scattering vector”, usually referred to by the term “hatch distance” was 0.11 mm. The metal layer had a thickness of 60 μm. The construction tray has been heated up to a temperature of 200° C.

The used powder had a particle size essentially from 3 μm to 100 μm, with a median of 39 μm, a 10% fractile of 16 μm and a 90% fractile of 76 μm. The powder has been formed from an alloy ingot by implementing a Nanoval atomizer, at a temperature of 850° C. and a pressure difference of 4 bar. The powder resulting from atomization has been filtered by size, the filtration size being 90 μm.

The first test parts have been made in the form of cylinders with a diameter of 11 mm and a height of 46 mm. The cylindrical first test parts have been used to make specimens intended for tensile tests. Second test parts have been made, in the form of parallelepipeds having 12 mm×45 mm×46 mm dimensions. The second test parts have been used to perform electrical conductivity tests. All parts have been subjected to a post-manufacture stress relief treatment of 4 hours at 300° C.

Some parts, whether these consist of first test parts or of second test parts, have been subjected to an additional post-manufacture heat treatment at 350° C., 400° C. or 450° C., the duration of the treatment being from 1 h to 100 h.

The first parts (with and without post-manufacture heat treatment) have been machined to obtain cylindrical tensile specimens having the following characteristics in mm (cf. Table 1 and FIG. 4): In FIG. 4 an Table 1, 0 represents the diameter of the central portion of the specimen, M the width of the two ends of the specimen, LT the total length of the specimen, R the radius of curvature between the central portion and the ends of the specimen, Lc the length of the central portion of the specimen and F the length of the two ends of the specimen. The values mentioned in Table 1 are in millimeters.

TABLE 1

| Ø | M | LT | R | Lc | F |
|---|---|---|---|---|---|
| 4 | 8 | 45 | 3 | 22 | 8.7 |

The specimens obtained in this manner have been tested in tension at room temperature according to the standard NF EN ISO 6892-1 (2009-10).

Table 2 represents, for each test part, the heat treatment duration, the heat treatment temperature (° C.), the 0.2% yield strength Rp0.2 (MPa), the electrical conductivity (MS·m⁻¹) as well as the thermal conductivity (W/m/K). The yield strength has been determined from specimens formed with the first test parts, according to the direction of manufacture Z, that is to say lengthwise. The electrical conductivity has been determined on the second test parts using a Foerster Sigmatest 2.069 apparatus at 60 kHz, after polishing these using a 180 grit sandpaper. The thermal conduction properties have been calculated from the measured electrical conductivity, based on the aforementioned linear relationship.

In Table 2, the 0 h duration corresponds to an absence of heat treatment on completion of the stress relief.

TABLE 2

| Temperature | Duration | Rp0.2 | σ | |
|---|---|---|---|---|
| (° C.) | (h) | (MPa) | (MS/m) | W/m/K |
| 0 | — | 196 | 27.25 | 180.27 |
| 350 | 14 | 144 | 28.3 | 186.73 |
| 350 | 56 | 143 | 28.56 | 188.33 |
| 400 | 1 | 150 | 28.36 | 187.10 |
| 400 | 4 | 150 | 28.27 | 186.55 |
| 400 | 10 | 146 | 28.58 | 188.45 |
| 400 | 100 | 138 | 28.36 | 187.10 |
| 400 | 1 | 146 | 28.36 | 187.10 |
| 400 | 4 | 142 | 28.27 | 186.55 |
| 400 | 10 | 141 | 28.58 | 188.45 |
| 400 | 100 | 135 | 28.36 | 187.10 |
| 450 | 104 | 120 | 27.89 | 184.21 |

FIG. 2 represents results disclosed in Table 2. FIG. 2 illustrates the tensile properties (ordinate axis, representing the yield strength Rp0.2 expressed in MPa) as a function of the thermal conductivity properties (abscissa axis, representing the thermal conductivity expressed in MS/m).

Without the application of a heat treatment, the mechanical properties are deemed to be satisfactory, with a yield strength Rp0.2 reaching 196 MPa. The same applies for conduction properties: without a heat processing, the electrical conductivity is equal to 27.25 MS/m. It is recalled that the electrical conductivity of pure aluminum is close to 34 MS/m.

The application of a heat treatment leads to an increase in the conductivity, in the range of 1 MS/m, at the expense of the yield strength (a decrease by about 50 MPa).

These results show that following the manufacture of the part, the application of a heat treatment, at a temperature higher than 300° C., is not necessary. The mechanical or thermal or electrical conduction properties are satisfactory without any heat treatment, besides the possible stress relief.

A second series of tests has have been performed using an alloy whose composition included, besides Al, Ni: 5%, Fe: 2% impurities: <0.05% with cumulated impurities <0.15%. First test parts and second test parts have been made, as described in connection with the first test. All parts have been subjected to a stress relief at 300° C. for 4 hours.

Some parts, whether these consist of first test parts or of second test parts, have been subjected to a post-manufacture heat treatment at 400° C., the duration of the treatment being either 1 h, or 4 h.

Table 3 represents, for each test part, the heat treatment duration, the heat treatment temperature (° C.), the 0.2% yield strength Rp0.2 (MPa), the electrical conductivity (MS/m) as well as the thermal conductivity (W/m/K). The yield strength has been determined from specimens formed with the first test parts, according to the direction of manufacture Z. The electrical conductivity has been determined on the second test parts, after polishing these using a 180 grit sandpaper. The thermal conduction properties have been calculated from the measured electrical conductivity, based on the aforementioned linear relationship.

In Table 3, the 0 h duration corresponds to an absence of heat treatment on completion of the stress relief.

TABLE 3

| Temperature | Duration | Rp0.2 | σ | |
|---|---|---|---|---|
| (° C.) | (h) | (MPa) | (MS/m) | W/m/K |
| 0 | — | 241 | 21.37 | 144.09 |
| 400 | 1 | 176 | 24.31 | 162.18 |
| 400 | 4 | 166 | 24.65 | 164.27 |

In comparison with the first series of tests, an increase in the yield strength, but also a degradation of the conductivity properties, are observed. This confirms that, when the Ni concentration increases:
the electrical (or thermal) conductivity decreases;
the mechanical properties of the manufactured part improve.

Thus, it seems that a weight fraction of Ni in the range 3.5%-6% or, even better, in the range of 3.5%-5% corresponds to a better trade-off between the mechanical properties and the conduction properties.

1. A method for manufacturing a part including a formation of successive metallic layers, superimposed on one another, each layer being formed by the deposition of a filler metal, the filler metal being subjected to an energy input so as to melt and constitute, when solidifying, said layer, the method being wherein the filler metal is an aluminum alloy comprising following alloy elements (weight %):
Ni: >3% and ≤7%;
Fe: 0%-4%;
optionally Zr: ≤0.5%;
optionally Si: ≤0.5%;
optionally Cu: ≤1%;
optionally Mg: ≤0.5%;
other alloy elements: <0.1% individually, and <0.5% all in all;
impurities: <0.05% individually, and <0.15% all in all;
the remainder aluminum.

2. The method according to claim 1, wherein the other alloy elements are selected from: Cr, V, Ti, Mn, Mo, W, Nb, Ta, Sc, Zn, Hf, Nd, Ce, Co, La, Ag, Li, Y, Yb, Er, Sn, In, Sb, Sr, Ba, Bi, Ca, P, B and/or a mischmetal.

3. The method according to claim 1, wherein Ni: 3.5%-6%, optionally Ni: 3.5%-5%;

4. The method according to claim 1, wherein Fe: 0.5%-3%;

5. The method according to claim 1, wherein the weight fraction of each other alloy element is lower than 500 ppm, or lower than 300 ppm, or lower than 200 ppm, or lower than 100 ppm.

6. The method according to claim 1, wherein Si: ≤0.2% or Si: ≤0.1%.

7. The method according to claim 1, wherein Cu: ≤0.2% or Cu: ≤0.1%.

8. The method according to claim 1, wherein Mg: ≤0.2% or Mg: ≤0.1%.

9. The method according to claim 1, following formation of the layers, an application of a heat treatment, optionally a stress relief or a tempering or an annealing.

10. The method according to claim 9, wherein the heat treatment is performed at a temperature from 200° C. to 500° C.

11. The method according to claim 1, including no quenching-type heat treatment following formation of the layers.

12. The method according to claim 1, wherein the filler metal is in the form of a powder, whose exposure to a beam of light or of charged particles results in a local melting followed by a solidification, so as to form a solid layer.

13. The method according to claim 1, wherein the filler metal is derived from a filler wire, whose exposure to a heat source results in a local melting followed by a solidification, so as to form a solid layer.

14. A metallic part obtained by the method object of claim 1.

15. A powder, intended to be used as a filler material of an additive manufacturing method, wherein said powder comprises an aluminum alloy, including the following alloy elements (weight %):
Ni: >3% and ≤7%;
Fe: 0%-4%;
optionally Zr: ≤0.5%;
optionally Si: ≤0.5%;
optionally Cu: ≤1%;
optionally Mg: ≤0.5%;
other alloy elements: <0.1% individually, and <0.5% all in all;
impurities: <0.05% individually, and <0.15% all in all;
remainder comprising aluminum.
